(19) United States
(12) Patent Application Publication
(10) Pub. No.: US 2020/0063483 A1
(43) Pub. Date: Feb. 27, 2020

(54) FURNITURE DRIVE

(71) Applicant: Julius Blum GmbH, Hoechst (AT)

(72) Inventor: Andreas HOLZAPFEL, Bregenz (AT)

(21) Appl. No.: 16/667,260

(22) Filed: Oct. 29, 2019

Related U.S. Application Data
(63) Continuation of application No. PCT/AT2018/000044, filed on May 8, 2018.

(30) Foreign Application Priority Data
May 12, 2017 (AT) A 50406/2017

(51) Int. Cl. E05F 1/12; E05D 3/06

(52) U.S. Cl. CPC E05F 1/1253; E05Y 2900/20; E05D 3/06

(57) ABSTRACT

A furniture drive for moving a furniture part movably supported relative to a furniture carcass the furniture drive includes a housing having a first housing wall to be fixed to the furniture carcass, and a second housing wall which is at least partially spaced from the first housing wall. At least the first housing wall includes at least one guide device for guiding a fastening means. At least one supporting body is configured so as to be separate from the at least one guide device for guiding the fastening means, at least partially surrounds the at least one guide device, and is firmly connected to the first housing wall as well as to the second housing wall so that a movement of the second housing wall relative to the first housing wall is restrained.

### BACKGROUND OF THE INVENTION

The present invention relates to a furniture drive for moving a furniture part movably supported relative to a furniture carcass, the furniture drive comprising a housing having a first housing wall to be fixed to a furniture carcass and a second housing wall which is at least partially spaced from the first housing wall. At least the first housing wall includes at least one guide device for guiding a fastening means.

The invention further concerns an item of furniture comprising a furniture carcass, a furniture part movably supported relative to the furniture carcass and a furniture drive of the type to be described.

WO 2017/059471 A shows in FIGS. 5a, 5b a furniture fitting in the form of a furniture drive for moving furniture flaps, and the furniture fitting can be mounted to a furniture carcass by a fastening device. The fastening device includes at least two fastening elements configured to be inserted into a common cylindrical bore. By rotating an arresting element, the fastening elements can be moved into an expanded position, so that the fastening elements, in the expanded position, are held within the bore in a force-locking manner.

DE 20 2016 101 285 U1 discloses a furniture drive for moving furniture flaps, in which the furniture drive includes a recess for receiving a pin. In a first mounting step, the pin is pre-mounted to a furniture carcass, and, in a subsequent mounting step, the furniture drive is locked to the pin by introducing the pre-mounted pin into the recess, whereby the furniture drive can be fixed to the furniture carcass.

DE 10 2007 049 143 A1 discloses a furniture fitting to be mounted to a chipboard plate. A supporting body is arranged in an expanded space of the furniture fitting, the expanded space being configured so as to broaden towards the chipboard plate. The supporting body is configured to receive a screw and rests against the chipboard plate in the mounted condition, so that in a region of the expanded space, the danger of tearing out the screw and a breaking out of the wood material from the chipboard plate can be reduced.

The housing of such furniture drives is usually mounted to a furniture carcass by fastening means, for example by screws. For this purpose, the housing of the furniture drive includes a guide device (for example a hole or a cylindrical portion) for guiding and/or receiving the fastening means. Upon screwing the housing to the furniture carcass and/or upon moving heavy furniture parts, it may happen that the housing is deformed, twisted or sagged due to the occurring forces. Thereby, an undesired relative movement between the two housing walls takes place, whereby the hinge axis members of the furniture drive are displaced relative to one another and the frictional forces are massively increased. In some cases, this may eventually lead to the fact that the movable furniture part can no longer be moved or can only be sluggishly actuated due to the restraints of the furniture drive.

### SUMMARY OF THE INVENTION

It is an object of the present invention a propose a furniture drive of the type mentioned in the introductory part, thereby avoiding the drawbacks as discussed above.

According to the invention, it is thus provided that at least one supporting body is provided, the supporting body being configured so as to be separate from the at least one guide device for guiding the fastening means, at least partially surrounds the at least one guide device and being firmly connected to the first housing wall as well as to the second housing wall, so that a movement of the second housing wall relative to the first housing wall is restrained.

In other words, at least one supporting body is provided for stabilizing the housing, and the at least one supporting body is arranged between the first and second housing wall and is firmly connected to both the first housing wall and the second housing wall. The guide device for receiving and/or guiding the fastening means is thereby at least partially surrounded by the at least one supporting body, so that the guide device is stabilized by the supporting body and is largely decoupled form the remaining portions of the housing wall. In this way, the housing walls can be stabilized to one another, so that the parallel positions of the hinge axis members of the furniture drive can also be maintained to one another.

According to an embodiment, it can be provided that the at least one supporting body is configured so as be V-shaped or U-shaped. The at least one supporting body can have at least two limbs forming an, preferably acute, angle to one another.

According to a further embodiment, it can be provided that the at least one supporting body surrounds the guide device over an angle range of at least 180°.

The at least one supporting body, which is preferably made of metal, can be welded, riveted or clinched to the first housing wall and/or the second housing wall.

### BRIEF DESCRIPTION OF THE DRAWINGS

Further details and advantages of the invention result from the following description of figures, in which:

FIG. 1a, 1b show an item of furniture with a furniture part movably supported relative a furniture carcass, and a furniture drive for moving the movable furniture part,

FIG. 2 shows the furniture drive in a perspective view,

FIG. 3 shows the housing of the furniture drive in an exploded view,

FIG. 4a, 4b show the first housing wall in a perspective view and in a side view,

FIG. 5a, 5b show a cross-sectional view of the furniture drive and an enlarged detail view thereof.

### DETAILED DESCRIPTION OF THE INVENTION

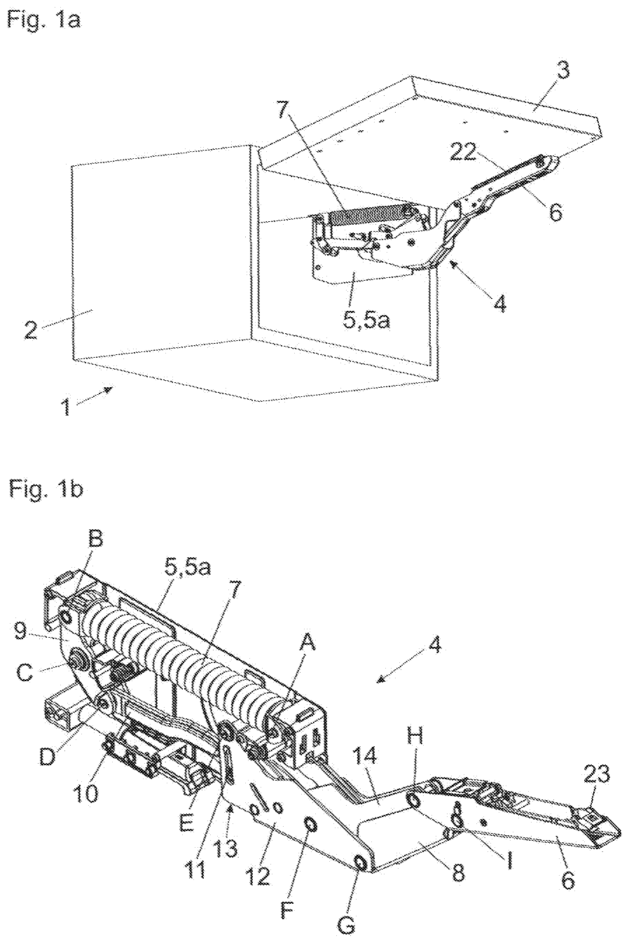

FIG. 1a shows a perspective view of an item of furniture 1, in which a movable furniture part 3 is pivotally supported by a furniture drive 4 about a horizontally extending pivoting axis relative to a furniture carcass 2. By the furniture drive 4, the movable furniture part 3 can be moved from a vertical closed position into an elevated position relative to the furniture carcass 2 (and in the opposite direction). The furniture drive 4 includes a housing 5 having a first housing wall 5a to be fixed to the furniture carcass 2, and an actuating arm 6 configured to be pivoted relative to the housing 5 for moving the movable furniture part 3. A spring device 7 is provided for applying a force to the actuating arm 6, and the spring device 7 at least partially compensates for a weight of the movable furniture part 3. As a result, the opening movement of the movable furniture part 3 can be facilitated for an operator. By a locking device 23 (see FIG. 1b), the actuating arm 6 can be releasably locked to a fitting portion 22 configured to be fixed to the movable furniture part 3.

FIG. 1b shows the furniture drive 4 according to a possible embodiment. The spring device 7 (for example at least one helical spring configured as a compression spring) is supported on the first housing wall 5a. The spring device 7 is supported on a stationary hinge axis member A and presses against the hinge axis member B. The hinge axis member B is supported on a first lever end of a two-armed deflection lever 9, and the deflection lever 9 is pivotally mounted about the hinge axis member C. The second lever end of the deflection lever 9 is connected via the hinge axis member D to a push lever 10, and the push lever 10 is hingedly connected to a pivoting lever 12 which is pivotally mounted about the pivoting axis E. By an actuation of an adjustment device 13, the distance of a pin 11 relative to the hinge axis member E can be adjusted along a guide of the pivoting lever 12. As a result, the operative lever arm between the pin 11 and the hinge axis member E can be varied, so that a torque from the spring device 7 applied to the actuating arm 6 can be adjusted according to the respective weight of the movable furniture part 3. The pivoting lever 12 is hingedly connected to a first lever 8 and a second lever 14 via the hinge axis members F and G. The first lever 8 and the second lever 14 are hingedly connected to the actuating arm 6 via the hinge axis members H and I.

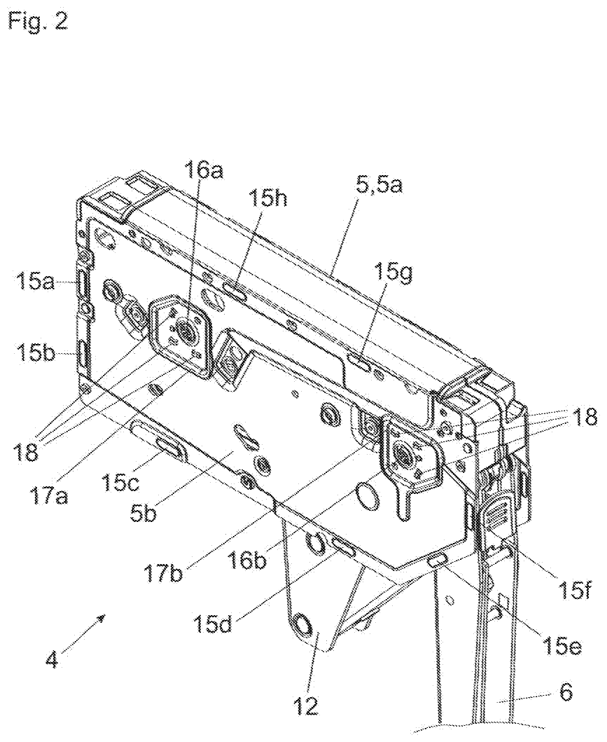

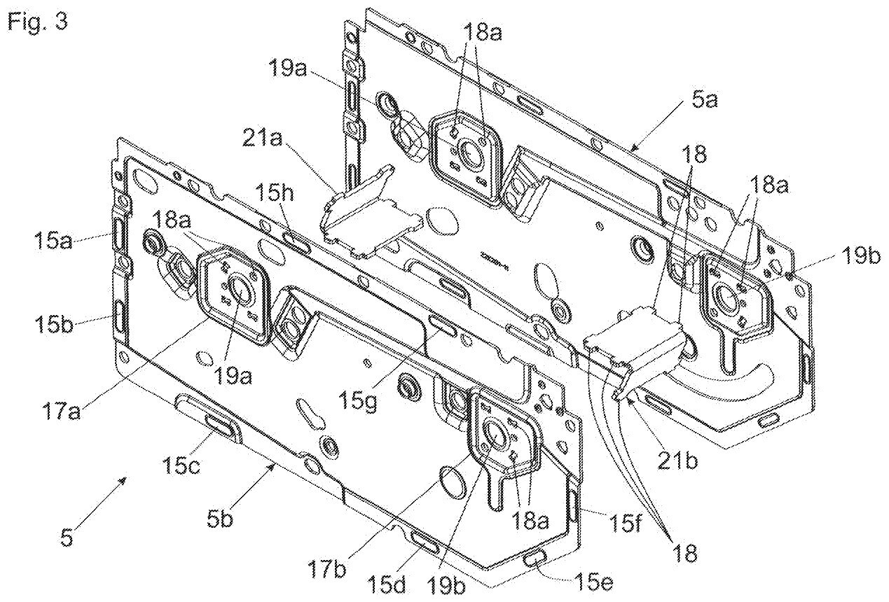

FIG. 2 shows the furniture drive 4 in a perspective view. The housing 5 includes a first housing wall 5a configured to bear against the furniture carcass 2, and a second housing wall 5b. The first housing wall 5a and the second housing wall 5b are at least partially spaced from one another. By first and second fastening means 16a and 16b, for example in the form of screws, the first housing wall 5a can be fixed to the furniture carcass 2. The second housing wall 5b is held on the first housing wall 5a by at least one supporting body 21a, 21b or a plurality of supporting bodies 21a, 21b (FIG. 3). The housing walls 5a, 5b can be configured so as to be identical in construction, apart from mirror-inverted components, so that the comments expressed here in connection with the first housing portion 5a in each case do also apply for the second housing portion 5b (and vice versa). Such a symmetric configuration of the furniture drive 4 has the particular advantage that the furniture drive 4, in addition to a simple production, can alternatively be fixed to a left or to a right sidewall of the furniture carcass 2. Each of the housing walls 5a, 5b includes a plurality of protrusions 15a-15h spaced from each other, and the protrusions 15a-15h are configured to bear against the furniture carcass 2. Accordingly, a large part of the housing walls 5a, 5b are spaced from the furniture carcass 2 in the mounted condition of the furniture drive 4.

Visible are, preferably window-shaped, supporting rims 17a and 17b protruding from the housing walls 5a, 5b and surrounding the fastening means 16a, 16b at least partially in the mounted position. Each of the supporting rims 17a and 17b are configured to bear against the furniture carcass 2, so that the housing 5 is connected, preferably exclusively, to the furniture carcass 2 via the protrusions 15a-15h and via the supporting rims 17a, 17b in the mounted condition. Within the supporting rims 17a, 17b, fastening locations 18 of supporting bodies 21a, 21b (see FIG. 3) are arranged, and the supporting bodies 21a, 21b are firmly connected to the housing walls 5a, 5b, preferably by welding, riveting or clinching. The protrusions 15a-15h and/or the supporting rims 17a, 17b can be configured as embossings.

FIG. 3 shows the housing 5 in an exploded view. The two housing walls 5a, 5b are substantially plate-shaped and can be identical in construction. Visible are the protrusions 15a-15h and the supporting rims 17a, 17b by which the housing 5 can be supported on the furniture carcass 2 in the mounted condition. Each of the housing walls 5a, 5b includes at least one guide device 19a, 19b for guiding a fastening means 16a, 16b (see FIG. 2), and at least one supporting body 21a, 21b is formed separately from the guide devices 19a, 19b.

In the mounted position, each of the supporting bodies 21a, 21b are connected to the plate-shaped housing walls 5a, 5b and at least partially surround the guide devices 19a, 19b, so that a movement of the two housing walls 5a, 5b relative to one another is prevented or restrained. In the shown embodiment, two supporting bodies 21a, 21b are provided, and the two supporting bodies 21a, 21b are spaced from each other in a longitudinal direction of the housing 5. The supporting bodies 21a, 21b are thereby formed as V-shaped profile portions, and the fastening locations 18 of the supporting bodies 21a, 21b engage in corresponding recesses 18a of the housing walls 5a, 5b in the mounted position.

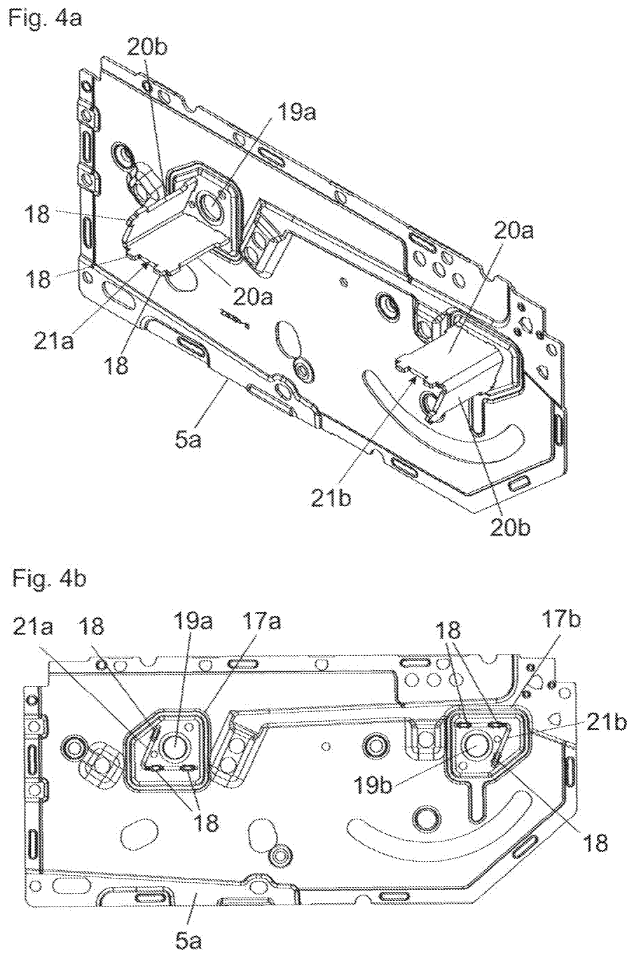

FIG. 4a shows the first housing wall 5a with the supporting bodies 21a, 21b for stabilizing the second housing wall 5b. Each of the supporting bodies 21a, 21b can have two limbs 20a, 20b connected to one another, and the limbs 20a, 20b forming an, preferably acute, angle to one another. Each of the supporting bodies 21a, 21b, on a side facing towards the housing walls 5a, 5b, includes a fastening location 18 engaging in the recesses 18a (FIG. 3) of the housing walls 5a, 5b. In the shown figure, the first supporting body 21a and the second supporting body 21b are arranged so as to be offset to one another by 180°, whereby the second housing wall 5b can be stabilized relative to the first housing wall 5a in a plurality of movement directions.

FIG. 4b shows a side view of the first housing wall 5a, in which the arrangement of the first and second supporting body 21a, 21b relative to the guide devices 19a, 19b emerges in greater detail. The fastening locations 18 of the supporting bodies 21a, 21b are thereby arranged with a distance as large as possible relative to a middle axis of the guide devices 19a, 19b, whereby an improved moment of resistance is brought about when the furniture drive 4 is loaded. Each of the supporting rims 17a, 17b can be configured as an embossing, whereby the risk of a deformation of the housing walls 5a, 5b can be reduced upon screwing to the furniture carcass 2. In the shown figure, the fastening locations 18 of the supporting bodies 21a, 21b are arranged in a, preferably equilateral, triangle, so that the furniture drive 4 is suitable for receiving high loads due to the shown triangular support.

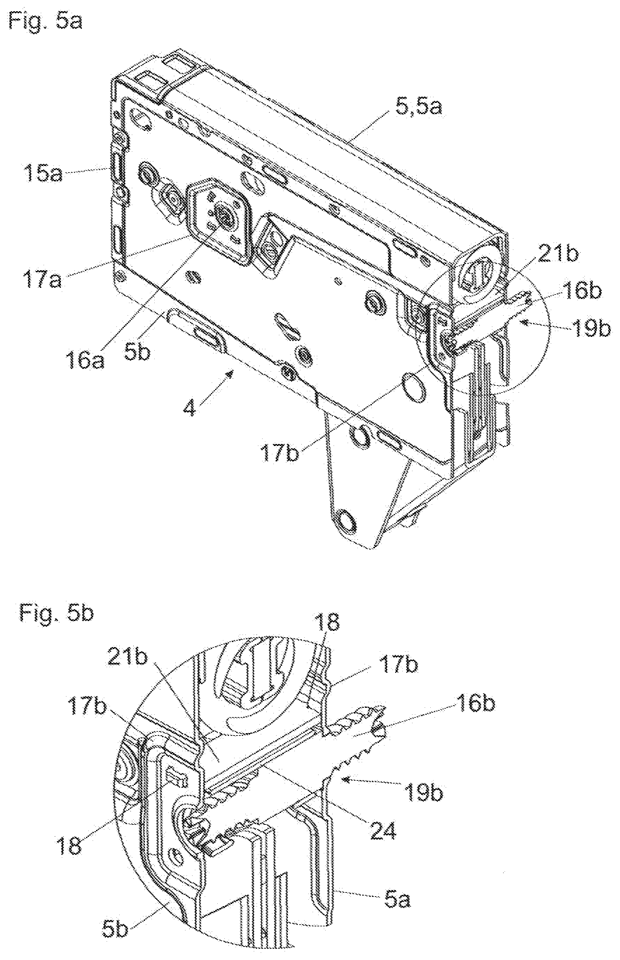

FIG. 5a shows a cross-sectional view of the furniture drive 4, while FIG. 5b shows the encircled region of FIG. 5a in an enlarged view. The guide device 19b for receiving and/or guiding the fastening means 16b, preferably a screw, can have a two-part or a multi-part configuration and additionally includes a cylindrical portion 24 (FIG. 5b), for example in the form of a sleeve, for guiding the fastening means 16b. The supporting body 21b is configured so as to be separate from that guide device 19b, i.e. that the supporting body 21b is not provided for guiding the fastening means 16b and is therefore configured so as to be contactless to the guide device 19b. Visible are the fastening locations 18 of the supporting body 21b, the fastening locations 18 being firmly connected to the first housing wall 5a on the one hand and to the second housing wall 5b on the other hand. Further visible are the transversely protruding supporting rims 17b for stabilizing the housing walls 5a, 5b, and the supporting rims 17b may be produced by an embossing operation for example. The first housing wall 5a is to be fixed to the furniture carcass 2 by the fastening means 16a, 16b. The second housing wall 5b, on the contrary, is supported on the first housing wall 5a by at least one or a plurality of supporting bodies 21a, 21b.

1. A furniture drive for moving a furniture part movably supported relative to a furniture carcass, the furniture drive comprising:
a housing having a first housing wall to be fixed to the furniture carcass, and a second housing wall which is at least partially spaced from the first housing wall, wherein at least the first housing wall includes at least one guide device for guiding a fastening means,
wherein at least one supporting body is provided, the supporting body being configured so as to be separate from the at least one guide device for guiding the fastening means, at least partially surrounds the at least one guide device and being firmly connected to the first housing wall as well as to the second housing wall, so that a movement of the second housing wall relative to the first housing wall is restrained.

2. The furniture drive according to claim 1, wherein the at least one supporting body includes at least two limbs connected to one another, and the limbs forming an, preferably acute, angle to one another.

3. The furniture drive according to claim 1, wherein the at least one supporting body surrounds the guide device over an angle range of at least 180°.

4. The furniture drive according to claim 1, wherein the at least one supporting body is welded, riveted or clinched to the first housing wall and/or to the second housing wall.

5. The furniture drive according to claim 1, wherein the at least one supporting body includes at least one fastening location engaging in a corresponding recess of a housing wall.

6. The furniture drive according to claim 5, wherein the supporting body includes at least two fastening locations, a first fastening location engaging in a corresponding recess of the first housing wall and a second fastening location engaging in a corresponding recess of the second housing wall.

7. The furniture drive according to claim 1, wherein the at least one supporting body consists of a metallic material.

8. The furniture drive according to claim 1, wherein the guide device is at least partially, preferably entirely, surrounded by a supporting rim protruding from the first housing wall.

9. The furniture drive according to claim 8, wherein the at least one supporting body is at least partially, preferably entirely, arranged within the supporting rim.

10. The furniture drive according to claim 1, wherein the first housing wall includes at least a second guide device for guiding a second fastening means, wherein at least one second supporting body at least partially surrounds the second guide device.

11. The furniture drive according to claim 10, wherein the first supporting body and the second supporting body are arranged so as to be offset to one another by 180°.

12. The furniture drive according to claim 1, wherein the first housing wall and/or the second housing wall includes or include a plurality of protrusions configured to bear against the furniture carcass, and the protrusions are spaced from one another.

13. The furniture drive according to claim 1, wherein the first housing wall and the second housing wall are identical in construction.

14. The furniture drive according to claim 1, wherein the furniture drive includes at least one pivotally mounted actuating arm for moving the movable furniture part, and a spring device for applying a force to the actuating arm.

15. An item of furniture comprising a furniture carcass, a furniture part movably supported relative to the furniture carcass, and at least one furniture drive according to claim 1 for moving the movable furniture part.
